(19) United States
(12) Patent Application Publication
(10) Pub. No.: US 2007/0168443 A1
(43) Pub. Date: Jul. 19, 2007

(54) System and method for managing an instant messaging contact list

(76) Inventor: Fabian F. Morgan, Austin, TX (US)

Correspondence Address: IBM CORP. (CLG);c/o CARDINAL LAW GROUP, 1603 ORRINGTON AVENUE, SUITE 2000, EVANSTON, IL, 60201, US

(21) Appl. No.: 11/334,227

(22) Filed: Jan. 18, 2006

(51) Int. Cl. G06F 15/16

(52) U.S. Cl. 709/207

(57) ABSTRACT

A method and system of managing an instant messaging contact list. A contact list is provided for each member of a user group. A status update is received relating to a target member. A determination is made whether the target member is contained on at least one user group member's instant messaging contact list based on the status update. The target member is removed from the instant messaging contact list of the at least one user group member based on the determination.

### TECHNICAL FIELD OF THE INVENTION

The present invention relates generally to computer systems and in particular to the management of an instant messaging contact list

### BACKGROUND OF THE INVENTION

Numerous computer users are using software that enables them to be alerted when friends, family, and colleagues go on-line for a real time exchange of messages. A commonly used term for this type of real-time exchange is instant messaging (IM). IM is relatively inexpensive, with most vendors freely distributing the product and others charging nominal licensing fees. It is also a powerful technology, allowing users to communicate in one window while, for example, reviewing a document in another. In a corporate environment, team members in different locations can set up impromptu conversations, bouncing ideas and strategies off each other.

Many users in corporate environments utilize IM software to connect with their counterparts worldwide. A lot of communication occurs on an “as-need” basis, and is done infrequently. It is not uncommon for users to discover that an employee has left the company after the fact. Meanwhile, the contact information of the former employee has become invalid and now unnecessarily occupies an entry on IM contact lists. What is needed, then, is a strategy for automatically removing invalid contact information from IM contact lists.

Publish subscribe groups are forums where individuals can subscribe in order to receive information on various topics. In a publish-subscribe system, the routing of messages from a publisher to a subscriber is controlled by a “middleman”, such as a server, which is responsible for routing the correct information from the producer to the consumer. Publish-subscribe systems provide a clear decoupling of the message producer and consumer roles that interacting entities might have. One advantage of publish-subscribe communication systems is that they function with both multiple subscribers and multiple publishers. Thus, a channel can receive data from a number of publishers and make the data available to a plurality of subscribers. It is common in a corporate environment for employees working on a project to be subscribed to the same forums as well as be listed on each other's contact list.

Therefore, it would be desirable to provide a strategy for maintenance of an IM contact list that would overcome the aforementioned and other disadvantages.

### SUMMARY OF THE INVENTION

One aspect of the present invention provides a method of managing an instant messaging contact list. The method includes providing a contact list for each member of a user group. A status update is received relating to a target member. A determination is made whether the target member is contained on at least one user group member's instant messaging contact list based on the status update. The target member is removed from the instant messaging contact list of the at least one user group member based on the determination.

Another aspect of the present invention provides a computer usable medium including a program for managing an instant messaging contact list. The medium includes computer readable program code for providing a user group, each member of the user group including an instant messaging contact list; and computer readable program code for receiving a status update relating to a target member. The medium further includes computer readable program code for determining whether the target member is contained on at least one user group member's instant messaging contact list based on the status update; and computer readable program code for removing the target member from the instant messaging contact list of the at least one user group member based on the determination.

Another aspect of the present invention provides a system of managing an instant messaging contact list. The system includes means for providing a user group, each member of the user group including the instant messaging contact list; and means for receiving a status update relating to a target member. The system further includes means for determining whether the target member is contained on at least one user group member's instant messaging contact list based on the status update; and means for removing the target member from the instant messaging contact list of the at least one user group member based on the determination.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIG. 1 illustrates a system of managing an instant messaging contact list in accordance with one embodiment of the present invention;

FIG. 2 illustrates a flow chart of a method of managing an instant message contact list, in accordance with one embodiment of the present invention;

FIG. 3 illustrates means for removing a target member from an instant messaging list, in accordance with one embodiment of the present invention; and

FIG. 4 illustrates one embodiment of a method for updating instant messaging contact information in accordance with one aspect of the invention.

### DETAILED DESCRIPTION OF THE PRESENTLY PREFERRED EMBODIMENTS

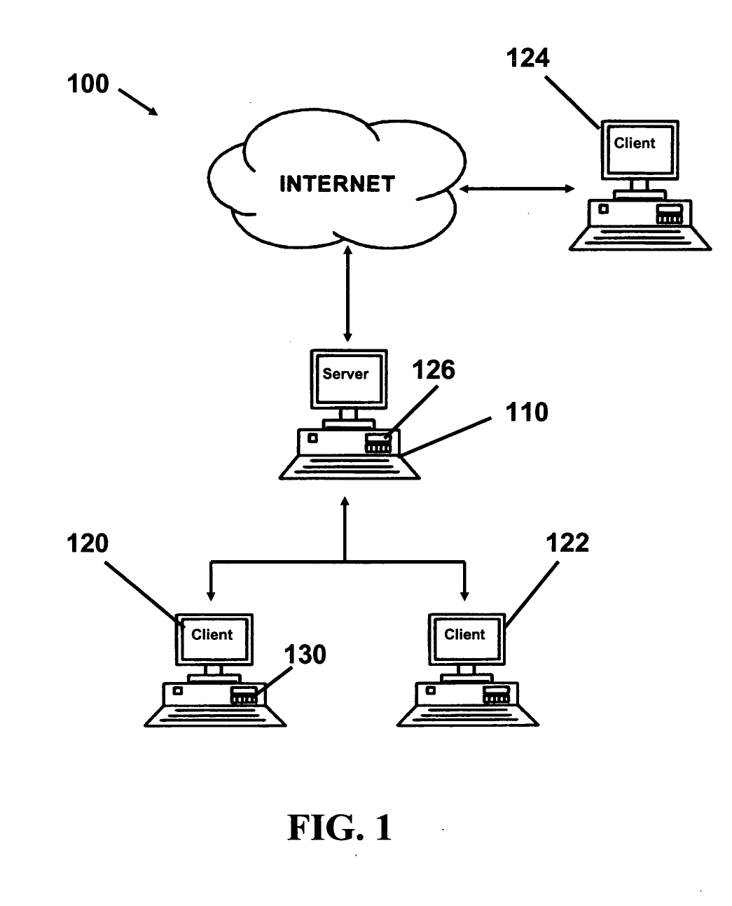

FIG. 1 illustrates a system for managing an instant messaging (IM) contact list, in accordance with one embodiment of the present invention, and shown generally by numeral 100. System 100 includes a server 110 linked to a plurality of client computers 120, 122, 124. Server 110 is electronically connected to the client computers 120, 122 forming a local area network (LAN). The server 110 is electronically connected to a remote client computer 124 through the Internet, thereby forming a wide area network (WAN). Those skilled in the art will appreciate that there are a myriad of types of computer connections and configurations that can be adapted for use with the present invention.

In one embodiment, the server 110 and client computers 120, 122, 124 include at least one storage disk 130. The storage disks 130 can be any type of storage devices capable of reading, writing, and storing data in the form of a database 126. For the purposes of this description, the term “disk” refers to any type of storage media including, but not limited to, magnetic disk drives (e.g. hard and floppy), optical drives (e.g. CDROM, CDR, CDR, DVD, DVDR, etc.), flash-type media, magnetic tape, holographic storage, paper tape, punched cards, printed and the like. In one embodiment, the storage disk stores IM contact information, such as an IM contact list.

In one embodiment, the server 110 runs an IM program. IM programs are software configured to allow substantially real-time communications, such as text, visual, audible, multimedia or file transfer, between at least two users of the program with minimal latency. In another or the same embodiment, one or more client computers 120, 122, 124 each run portions of the IM program (e.g., applets). At certain times of the IM program execution, actions and functions can be performed manually by a user (i.e., through mouse/keyboard/voice input at the server 110 and/or client computers 120, 122, 124) or automatically (i.e., through coding in the program). Client computers 120, 122, 124 can have one or more separate users. Client computers 120, 122, 124 maintain an IM contact list from which they can query and then exchange information with another computer in real-time. The IM contact list can be stored on a resident storage disk 130 of a given client computer 120, 122, 124 and/or the server 110. In one embodiment, a user maintains their own specific IM contact list even if they share a client computer 120, 122, 124 with others. In one embodiment, this specific IM contact list is available to the user each time the user “logs on” to the IM system, regardless of the computer that the user is operating.

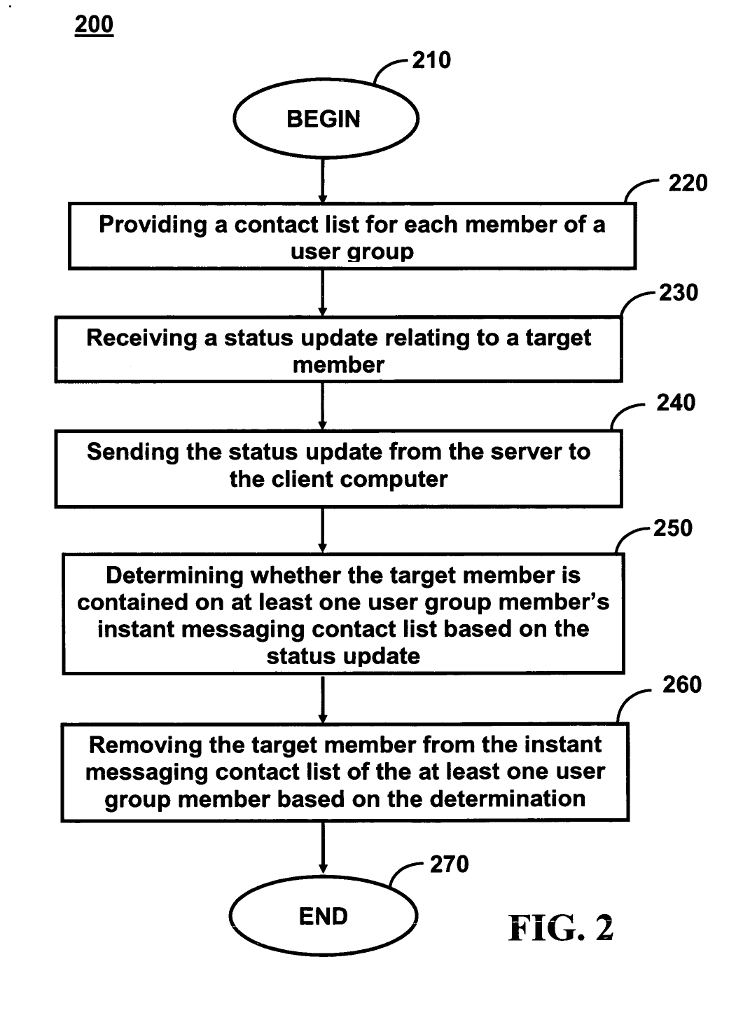

FIG. 2 illustrates a flowchart 200 of one embodiment of a method for managing an IM contact list, in accordance with one embodiment of the present invention. Method 200 begins at 210. The present invention can take the form of a computer usable medium including a program for managing an IM contact list in accordance with the present invention. The program, stored in the computer usable medium, includes computer program code for executing the method steps described and illustrated in FIG. 2. The program can be stored and executed by the server 110 and any of the client computers 120, 122, 124. In the description and figures, the present invention is described in the context of a corporate environment. Those skilled in the art will appreciate that the present invention can be adapted for use in a number of different settings.

At step 220, a contact list is provided for each member of a user group. In one embodiment, users can join a group by placing each other on their IM contact lists. For example, colleagues working on a given project can add each other to their IM contact lists for the purpose of exchanging ideas in the form of messages, files, and the like. In another or the same embodiment, one or more members of the group can join a publish-subscribe group. For example, employees of a company can subscribe to certain newsletters or feeds in order to be notified when updates occur on a given topic. The employee group members can receive the updates, for example, in the form of an e-mail newsletter. Publish-subscribe groups are known in the arr. In yet another embodiment, the group can include an entire company IM contact directory or a portion thereof.

At step 230, a status update is received relating to a target member. In one embodiment, the status update is received at the server 110. In another or the same embodiment, the status update is received at one or more of the client computers 120, 122, 124. The status update can be provided by a system administrator, personnel officer, group member, or the like. The status update includes information for updating an employee's status. For example, an employee who is a group member can be terminated, choose to leave the company, or simply opt out of the group, all of which would affect the IM contact lists of the other group members. In one embodiment, a status update indicating the status change is received directly at the server 110 or sent from a client computer 120, 122, 124, or by other means. Server 110 includes a database 126 of records, including such information as employee name, address, phone number, position within the company, IM contact list members, and the like.

At step 240, the status update is sent from the server 110 to one or more client computers 120, 122, 124. In one embodiment, the status update is sent to the client computers 120, 122, 124 when the status update is received by the server 110. In another embodiment, the status update is received directly by the client computers 120, 122, 124 from, for example, a user.

At step 250, a determination is made whether the target member is contained on at least one user group member's IM contact list based on the status update. In one embodiment, the determination is made at the server 110. In another embodiment, the determination is made at the client computer 120, 122, 124. The determination can be made by searching for the target member in the IM contact lists of the various members in the provided group.

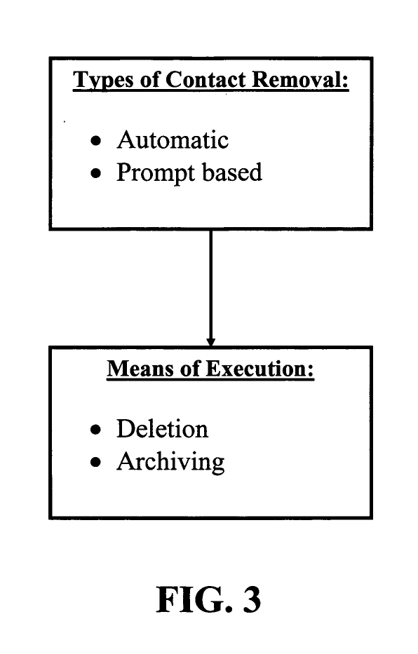

At step 260, the target member is removed from the instant messaging contact list of the at least one user group member based on the determination. As shown in FIG. 3, the removal of the target member may be accomplished in various ways. In one embodiment, employee A is removed automatically from the other group members IM contact lists. In addition, employee A's records can be removed from the database 126. In another embodiment, a prompt appears on a group member's screen, requesting instruction as to whether or not to have employee A removed from the members IM contact list. Should the group member decide to remove employee A's contact information, the contact information can either be deleted from the IM contact list or archived onto the database 126. Archiving the contact information includes removing the contact information from a user's IM contact list and storing the contact information at a location accessible to the IM contact list at a later time. This can be useful, for example, if employee A rejoins the company or project at a later time. The removal or archiving of employee A's information provides a strategy for updating a user's IM contact list.

Method 200 terminates at step 270 and is repeated as appropriate.

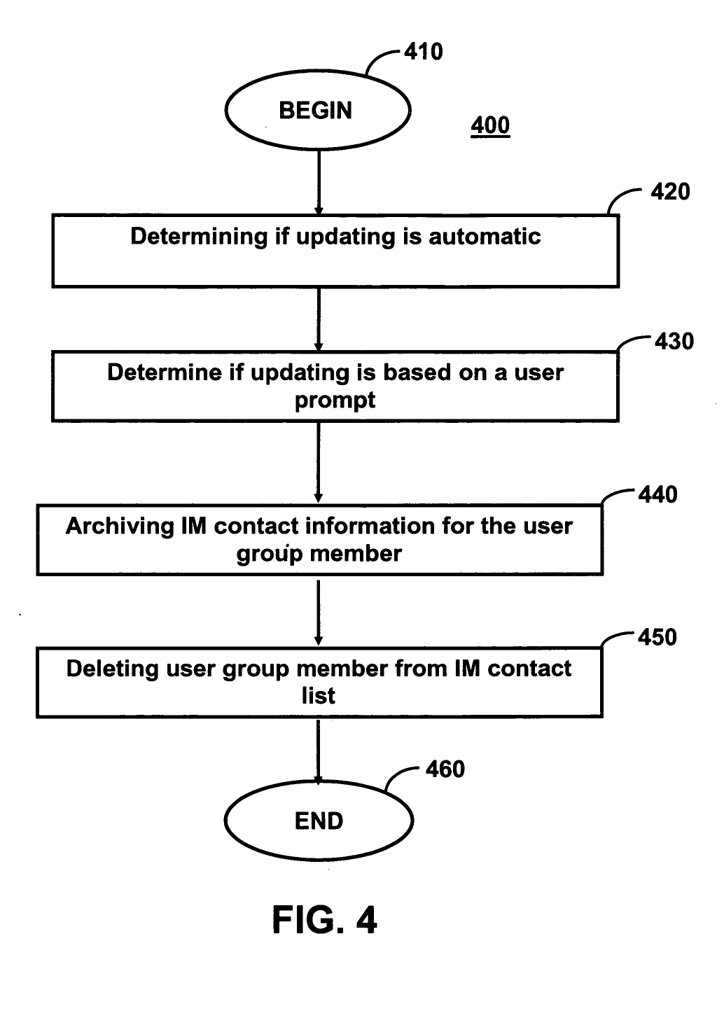

FIG. 4 illustrates one embodiment of a method 400 for updating an IM contact list, in accordance with one aspect of the invention. Method 400 begins at 410. The IM program determines if the IM program is to automatically update IM contact lists at step 420. At step 430, the IM program determines whether the updating of IM contact lists is based on user prompts. In response to one of the determinations, the IM program archives IM contact information for the user group member at step 440. In other embodiments, the IM program deletes the group member from the IM contact list at step 450.

The following are two examples of managing an IM contact list, in accordance with the present invention:

### EXAMPLE 1

A user group is provided, each member of the user group having an IM contact list. The user group includes those subscribed to a publish-subscribe group. A status update is received at a server indicative of the termination of employee A, known as the target member. A determination is made to select those user group members including employee A in their IM contact list. The determination is made at the server. The status update is sent from the server to the client computers of group members of a publish-subscribe group that include employee A in their IM contact list. Employee A is removed (e.g., automatically or based on a user prompt, and deleted or archived) from the IM contact lists of the user group based on the determination.

### EXAMPLE 2

A user group is provided, each member having an IM contact list. A status update is received at a client computer calling for the termination of employee A, known as the target member. The status update is uploaded to the server and sent to all pertinent client machines. The status update is received by every employee of company A (i.e., the group). A determination is made to select those user group members including employee A in their IM contact list. The determination is made at each client computer. Employee A is removed (e.g., automatically or based on a user prompt, and deleted or archived) from the IM contact lists of the user group members including employee A on each client.

It is important to note that the figures and description illustrate specific applications and embodiments of the present invention, and is not intended to limit the scope of the present disclosure or claims to that which is presented therein. While the figures and description present a program run on a master/client computer system, the present invention is not limited to that format, and is therefore applicable to other computer network formats. Upon reading the specification and reviewing the drawings hereof, it will become immediately obvious to those skilled in the art that myriad other embodiments of the present invention are possible, and that such embodiments are contemplated and fall within the scope of the presently claimed invention.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method of managing an instant messaging contact list, the method comprising:
providing a contact list for each member of a user group;
receiving a status update relating to a target member;
determining whether the target member is contained on at least one user group member instant messaging contact list based on the status update; and
removing the target member from the instant messaging contact list of the at least one user group member based on the determination.

2. The method of claim 1 wherein at least one group member belongs to a publish-subscribe group.

3. The method of claim 1 wherein the determination is made at a location selected from the group consisting of the server and a client computer.

4. The method of claim 1 wherein removing the at least group member is performed automatically.

5. The method of claim 1 wherein removing the group member is performed in response to a user prompt.

6. The method of claim 1 wherein removing the group member comprises deleting the group member from the instant message contact list.

7. The method of claim 1 wherein removing the at least one group member comprises archiving instant messaging contact information for the group member.

8. The method of claim 1 further comprising sending the status update from a server to a client computer.

9. A computer usable medium including a program for managing an instant messaging contact list, the program comprising:
computer readable program code for providing a contact list for each member of a user group;
computer readable program code for receiving a status update relating to a target member;
computer readable program code for determining whether the target member is contained on at least one user group member instant messaging contact list based on the status update; and
computer readable program code for removing the target member from the instant messaging contact list of the at least one user group member based on the determination.

10. The computer usable medium of claim 9 wherein at least one group member belongs to a publish-subscribe group.

11. The computer usable medium of claim 9 wherein the determination is made at a location selected from the group consisting of the server and a client computer.

12. The computer usable medium of claim 9 wherein removing the at least group member is performed automatically.

13. The computer usable medium of claim 9 wherein removing the group member is performed in response to a user prompt.

14. The computer usable medium of claim 9 wherein removing the group member comprises deleting the group member from the instant message contact list.

15. The computer usable medium of claim 9 wherein removing the at least one group member comprises archiving instant messaging contact information for the group member.

16. The computer usable medium of claim 9 further comprising computer readable program code for sending the status update from a server to a client computer.

17. A system of managing an instant messaging contact list, the system comprising:
means for providing a contact list for each member of a user group;
means for receiving a status update relating to a target member;
means for determining whether the target member is contained on at least one user group member instant messaging contact list based on the status update; and
means for removing the target member from the instant messaging contact list of the at least one user group member based on the determination.

18. The system of claim 17 further comprising means for sending the status update from a server to a client computer.
